(19) United States
(12) Patent Application Publication
(10) Pub. No.: US 2020/0211499 A1
(43) Pub. Date: Jul. 2, 2020

(54) METHOD AND APPARATUS FOR ADJUSTING DISPLAY BRIGHTNESS, DISPLAY DEVICE AND STORAGE MEDIUM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Jian SUN, Beijing (CN); Ziqiang GUO, Beijing (CN); Lin LIN, Beijing (CN); Yakun WANG, Beijing (CN)

(21) Appl. No.: 16/511,238

(22) Filed: Jul. 15, 2019

(30) Foreign Application Priority Data
Jan. 2, 2019 (CN) 201910003318.8

(51) Int. Cl. G09G 5/10; G06F 3/01

(52) U.S. Cl. CPC G09G 5/10; G09G 2360/144; G09G 2320/0626; G06F 3/012

(57) ABSTRACT

The invention discloses a method and an apparatus for adjusting display brightness, a display device and a storage medium. The method for adjusting the display brightness of the display device comprises the following steps: acquiring light intensity information around the display device and motion information of the display device; determining, according to the motion information, whether motion parameters in a preset duration are in a preset threshold range; if the motion parameters in a preset duration are in the preset threshold range, it is determined to adjust the display brightness of the display device according to the light intensity information; otherwise, it is determined not to adjust the display brightness of the display device according to the light intensity information.

### CROSS-REFERENCE TO RELATED APPLICATIONS

The present application claims priority to Chinese Patent Application No. 201910003318.8, filed on Jan. 2, 2019, which is hereby fully incorporated herein by reference in its entirety.

### TECHNICAL FIELD

Method and device for adjusting display brightness, display device and storage medium.

### BACKGROUND

With the development of wearable devices, head-mounted display devices are increasingly used in various fields. Furthermore, because head-mounted display devices can move along with the wearer, the usage scenarios thereof are changeable.

### SUMMARY

The invention provides a method for adjusting display brightness of a display device, which is used for the display device, the method comprises:

acquiring light intensity information around the display device and motion information of the display device;

determining, according to the motion information, whether motion parameters in a preset duration are in a first threshold range; and

if the motion parameters are in the first threshold range, determining to adjust the display brightness of the display device according to the light intensity information; otherwise, determining not to adjust the display brightness of the display device according to the light intensity information.

In one or more embodiments of the present application, the motion parameters include one or more of speed, acceleration, or rotation angle.

In one or more embodiments of the present application, determining to adjust the display brightness of the display device according to the light intensity information includes:

determining a light intensity interval to which the light intensity information around the display device belongs; and

determining a brightness coefficient of the light intensity interval to which the light intensity information belongs according to a preset mapping relationship between the light intensity interval and the brightness coefficient.

In one or more embodiments of the present application, the light intensity interval comprises an indoor light intensity interval and an outdoor light intensity interval; and the outdoor light intensity interval comprises a sunny interval and a cloudy interval.

In one or more embodiments of the present application, the sunny interval comprises an away-from-sun interval and a facing-sun interval.

The present disclosure also provides an apparatus for adjusting display brightness of a display device, which is used for the display device, the apparatus comprises:

an information acquisition unit configured to acquire light intensity information around the display device and motion information of the display device;

a determination unit configured to determine, according to the motion information, whether motion parameters in a preset duration are in a first threshold range; and

an adjustment unit configured to, if the motion parameters are in the first threshold range, determine to adjust the display brightness of the display device according to the light intensity information; otherwise, determine not to adjust the display brightness of the display device according to the light intensity information.

In one or more embodiments of the present application, the motion parameters include one or more of speed, acceleration, or rotation angle.

In one or more embodiments of the present application, the adjustment unit comprises:

a light intensity interval determination unit configured to determine a light intensity interval to which the light intensity information around the display device belongs; and

a brightness coefficient determination unit configured to determine a brightness coefficient of the light intensity interval to which the light intensity information belongs according to a preset mapping relationship between the light intensity interval and the brightness coefficient.

In one or more embodiments of the present application, the light intensity interval comprises an indoor light intensity interval and an outdoor light intensity interval; and the outdoor light intensity interval comprises a sunny interval and a cloudy interval.

In one or more embodiments of the present application, the sunny interval comprises an away-from-sun interval and a facing-sun interval.

The present disclosure also provides a head-mounted display device, which includes an apparatus for adjusting display brightness of a display device provided in the embodiments of the present application.

The present disclosure also provides a computer-readable storage medium storing a computer program, which when executed by a processor, implements the method for adjusting display brightness of a display device provided in the embodiments of the present application.

### BRIEF DESCRIPTION OF THE DRAWINGS

Other features, objects and advantages of the present application will become more apparent from the detailed description of non-limiting embodiments with reference to the following accompanying drawings:

FIG. 1 illustrates an exemplary flow diagram of a method for adjusting display brightness of a display device according to an embodiment of the present application;

FIG. 2 illustrates an exemplary flow diagram of an adjustment method of step S30 according to an embodiment of the present application;

FIG. 3 illustrates an exemplary flow diagram of a method for setting a mapping relationship between a light intensity interval and a brightness coefficient according to an embodiment of the application; and

FIG. 4 illustrates an exemplary block diagram of an apparatus for adjusting display brightness of a display device according to an embodiment of the present application.

FIG. 5 illustrates another exemplary block diagram of an apparatus for adjusting display brightness of a display device according to an embodiment of the present application.

### DETAILED DESCRIPTION

The present application will be further described in details below with reference to the accompanying drawings and embodiments. It is to be understood that the specific embodiments described herein are merely illustrative of the related art and are not the limitation to it. It should be noted that, for convenience of description, only the parts related to the invention are shown in the drawings.

It is to be noted that, without conflictions, the embodiments and the features in the embodiments of the present application can be combined mutually. The present application will now be described in detail with reference to the accompanying drawings in conjunction with the embodiments.

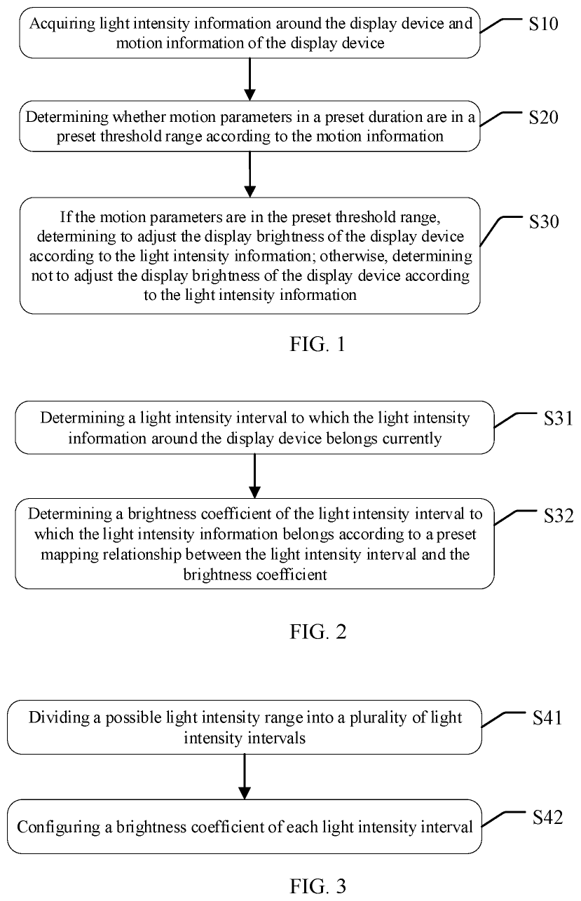

Referring to FIG. 1, an exemplary flow diagram of a method for adjusting display brightness of a display device according to an embodiment of the present application is it illustrated. The method comprises:

Step S10: acquiring light intensity information around the display device and motion information of the display device;

Step S20: determining whether motion parameters in a preset duration are in a preset threshold range according to the motion information;

Step S30: if the motion parameters are in the preset threshold range, determining to adjust the display brightness of the display device according to the light intensity information; otherwise, determining not to adjust the display brightness of the display device according to the light intensity information.

In step S10, the light intensity information and the motion information of the display device can be respectively acquired by providing a light sensor and a motion sensor on the display device. It is understood that the two types of information may be collected simultaneously, or the light intensity information may be collected firstly and the motion information may be collected secondly, or the motion information may be collected firstly and then the light intensity information may be collected secondly. It is not limited herein.

In step S20, it is determined whether the motion parameters in the preset duration are in a preset threshold range according to the motion information, that is, it is determined whether the display brightness needs to be adjusted when a change of light intensity occurs with reference to the motion information. The preset duration and the preset threshold can be set correspondingly according to actual requirements or application scenarios, which are not limited herein.

The method for adjusting display brightness in the related art sets the display brightness of the display device only based on an intensity of the light intensity information, and for some display devices, such as a head-mounted display device or a vehicle-mounted display device, the adjustment of brightness in such adjustment modes may instead bring discomfort to the wearer or go against the will of the wearer under some scenarios. For example, in a sunny day, when the wearer turns around in place quickly or performs a quick head raising or lowering action, an ambient light sensor collects different light intensity information in the directions facing and away from the sun. At this time, if the display brightness is continuously adjusted according to the light intensity information, the wearer will feel uncomfortable, and it is against the wear's will as well. Moreover, when a vehicle runs or a wearer runs quickly under a row of trees on the roadside, the light intensities of the display device under the trees and under the sunlight acquired by the ambient light sensor are different, and if the display brightness is continuously adjusted based on the light intensity information, an uncomfortable feeling will be brought to the wearer. Therefore, the present application determines whether the display brightness needs to be adjusted when a change of the light intensity occurs with reference to the motion information, which can bring a more comfortable visual experience to the wearer.

In step S30, it is determined whether it is necessary to adjust the display brightness according to the light intensity information, based on a determination result in step S20.

In some embodiments, the motion parameters include one or more of speed, acceleration, or rotation angle.

Specifically, when the light intensity changes, the size of the motion parameters within the preset duration is determined, and if the motion parameters are within a preset threshold range, the display brightness of the display device is adjusted according to the light intensity information. Otherwise, the display brightness of the display device is not adjusted. Motions of the wearer include motions that primarily change in distance (e.g., running), motions that primarily change in angle of rotation (e.g., circling), and motions that change both in distance and in angle of rotation (e.g., a combination of running and circling). The preset value is set according to the difference of the type of motion. In particular applications, the motion sensor may include a velocity sensor, an acceleration sensor, and/or a gyroscope, which respectively collect velocity, acceleration information, and rotation angle information. It is understood that motion parameters participating in the determination may be an average value of the parameters at certain moments within the duration, or a maximum value of the parameters, and which motion parameter is used may be set according to the actual application.

The way to adjust the display brightness is described below with reference to FIG. 2 and FIG. 3. FIG. 2 illustrates an exemplary flow diagram of an adjustment method of step S30 according to an embodiment of the present application, and FIG. 3 illustrates an exemplary flow diagram of a method for configuring of a mapping relationship between a light intensity interval and a brightness coefficient according to an embodiment of the application.

As shown in FIG. 2, the adjustment method includes:

Step S31, determining a light intensity interval to which the light intensity information around the display device belongs;

Step S32, determining a brightness coefficient of the light intensity interval to which the light intensity information belongs according to a preset mapping relationship between the light intensity interval and the brightness coefficient.

Here, the determination of the light intensity interval and the setting of the mapping relationship are described with reference to FIG. 3.

As shown in FIG. 3, the method for setting the mapping relationship between the light intensity interval and the luminance coefficient includes:

Step S41, dividing a possible light intensity range into a plurality of light intensity intervals;

Step S42, configuring a brightness coefficient of each light intensity interval.

In step S41, the display device can move over a wide range, and may move from indoor to outdoor. Furthermore, the indoor light intensity is also changed with the indoor lighting. The outdoor light intensity will vary depending on the intensity of the sunlight, weather conditions, and presence or absence of obstructions. Therefore, the possible light intensities of the scenarios are collected and divided into a plurality of light intensity intervals, which is beneficial to improving the precision of display brightness adjustment.

Specifically, the light intensity interval may include an indoor light intensity interval and an outdoor light intensity interval; or the light intensity interval may include an indoor light intensity interval, an outdoor sunny interval, and an outdoor cloudy interval; or the light intensity interval may include an indoor light intensity interval, an outdoor sunny away-from-sun interval, an outdoor sunny facing-sun interval, and an outdoor cloudy interval. The light intensity intervals may be set according to the order of the light intensity from strong to weak, or may be set according to the order of the light intensity from weak to strong. It may be specifically set according to the actual application.

In step S42, corresponding brightness coefficients are set according to each of the light intensity intervals divided in step S41. As for the magnitude of the brightness coefficients, corresponding values may be set according to the difference in application, which is not described herein.

In this embodiment, possible light intensity ranges of the scenarios may be divided into an outdoor sunny facing-sun interval, an outdoor sunny away-from-sun interval, an outdoor cloudy interval, and an indoor light intensity interval according to the order of the light intensity from strong to weak, and brightness coefficients λ1, λ2, λ3, and λ4 are correspondingly set. The way of adjusting the display brightness in different intervals is beneficial to improving the precision of adjusting the display brightness.

It should be noted that, in actual application, the number of divided intervals may be set according to the application scenario and the characteristics of the display device. For example, the light intensity range may be divided into an outdoor sunny facing-sun interval, an outdoor sunny away-from-sun interval, an outdoor cloudy interval, and an indoor light intensity interval. Alternatively, the outdoor cloudy interval may be further divided into a first outdoor cloudy interval and a second outdoor cloudy interval, and the indoor light intensity interval may be further divided into a first indoor light intensity interval and a second indoor light intensity interval. The brightness coefficients of the display device can be set according to the corresponding light intensity interval so as to realize the adjustment of the display brightness. The precision of the adjustment of the display brightness becomes higher as the number of the divided intervals becomes larger. The specific brightness coefficient is also set according to the characteristics and requirements of the display device, and is not limited herein.

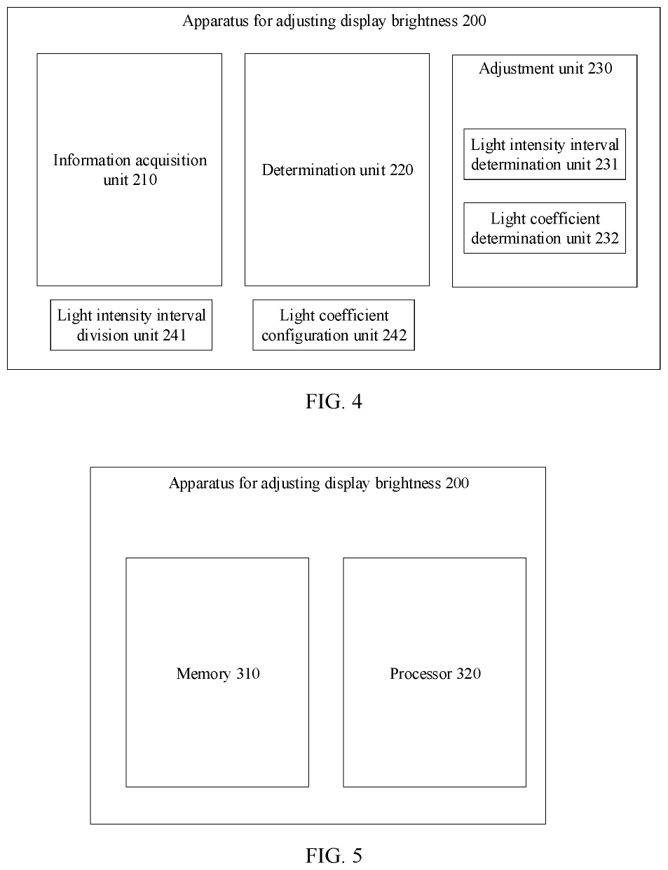

FIG. 4 illustrates an exemplary block diagram of a device for adjusting display brightness of a display device according to an embodiment of the present application. As shown in FIG. 4, the present application further provides an apparatus 200 for adjusting display brightness, the apparatus comprising:

an information acquisition unit 210 configured to acquire light intensity information around the display device and motion information of the display device;

a determination unit 220 configured to determine, according to the motion information, whether motion parameters in a preset duration are in a threshold range;

an adjustment unit 230 configured to, if the motion parameters are in the preset threshold range, determine to adjust the display brightness of the display device according to the light intensity information; otherwise, determine not to adjust the display brightness of the display device according to the light intensity information.

In some embodiments, the motion parameters include one or more of speed, acceleration, or rotation angle.

In some embodiments, the adjustment unit 230 includes:

a light intensity interval determination unit 231 configured to determine a light intensity interval to which the light intensity information around the display device belongs; and

a brightness coefficient determination unit 232 configured to determine a brightness coefficient of the light intensity interval to which the light intensity information belongs according to a preset mapping relationship between the light intensity interval and the brightness coefficient.

In some embodiments, the apparatus 200 for adjusting display brightness further comprises:

a light intensity interval division unit 241 configured to divide a possible light intensity range into a plurality of light intensity intervals; and

a brightness coefficient configuration unit 242 configured to arrange a brightness coefficient of each light intensity interval.

In some embodiments, the light intensity interval comprises an indoor light intensity interval and an outdoor light intensity interval; and the outdoor light intensity interval comprises a sunny interval and a cloudy interval.

In some embodiments, the sunny interval comprises an away-from-sun interval and a facing-sun interval.

The technical term “unit” used in the present disclosure is intended to mean a corresponding one of an analog circuit, a digital circuit, and a program module that implements a corresponding function, and which form of the analog circuit, the digital circuit, and the program module is used depends on an application scenario of the “unit” and the corresponding function to be implemented. The technical features related to “unit” such as the information acquisition unit 210, the determination unit 220, the adjustment unit 230, the light intensity interval determination unit 231, the brightness coefficient determination unit 232, the light intensity interval division unit 241, and the brightness coefficient configuration unit 242 according to the present disclosure may be a complex instruction set computing (CISC) microprocessor, a reduced instruction set computing (RISC) microprocessor, a very long instruction word (VLIW) microprocessor, a processor running other instruction sets, or a processor running a combination of instruction sets, or one or more special processing devices such as an application specific integrated circuit (ASIC), a field programmable gate array (FPGA), a digital signal processor (DSP), a system on chip (SoC), and the like.

As shown in FIG. 5, the present application further provides an apparatus 300 for adjusting display brightness of a display device, comprising a memory 310 configured to store computer-executable instructions and a processor 320 configured to execute the computer-executable instructions stored in the memory to implement at least a method for adjusting display brightness of a display device according to the present application.

The present application also provides a head-mounted display device, which includes an apparatus for adjusting display brightness of a display device provided in the embodiments of the present application.

As another aspect, the present application also provides a computer-readable storage medium, which may be a computer-readable storage medium included in the apparatus described in the above embodiments; or may be a computer-readable storage medium that is separately provided and not incorporated into the apparatus. The computer readable storage medium stores one or more programs executed by one or more processors to perform the method for adjusting display brightness of a display device described in the present application.

The flow diagrams and block diagrams in the figures illustrate the architecture, functionality, and operation that are possibly implemented by systems, methods and computer program products according to various embodiments of the present disclosure. In this regard, each block in the flow diagrams or block diagrams may represent a module, program segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The above descriptions are only preferred embodiments of the present application and are illustrative of the principles of the technology employed. It should be understood by those skilled in the art that the scope of the invention described in the present application is not limited to the technical solutions formed by specific combinations of the above-described technical features, and should be covered in other technical solutions formed by any combination of the above-described technical features or the equivalent thereof without departing from the concept of the present invention. For example, the technical solutions formed by the above features be replaced with (but not limited to) features having similar functions disclosed in the present application.

What is claimed is:

1. A method for adjusting display brightness of a display device, comprising:
acquiring light intensity information around the display device and motion information of the display device;
determining, according to the motion information, whether motion parameters in a preset duration are in a preset threshold range; and
if the motion parameters are in the preset threshold range, determining to adjust the display brightness of the display device according to the light intensity information; otherwise, determining not to adjust the display brightness of the display device according to the light intensity information.

2. The method for adjusting display brightness of a display device of claim 1, wherein the motion parameters include one or more of speed, acceleration, or rotation angle.

3. The method for adjusting display brightness of a display device of claim 1, wherein said adjusting the display brightness of the display device according to the light intensity information includes:
determining a light intensity interval to which the light intensity information around the display device belongs; and
determining a brightness coefficient of the light intensity interval to which the light intensity information belongs according to a preset mapping relationship between the light intensity interval and the brightness coefficient.

4. The method for adjusting display brightness of a display device of claim 3, wherein,
the light intensity interval comprises an indoor light intensity interval and an outdoor light intensity interval; and
the outdoor light intensity interval comprises a sunny interval and a cloudy interval.

5. The method for adjusting display brightness of a display device of claim 4, wherein the sunny interval comprises an away-from-sun interval and a facing-sun interval.

6. An apparatus for adjusting display brightness of a display device, wherein the apparatus comprises:
a memory configured to store computer-executable instructions,
a processor configured to execute the computer-executable instructions stored in the memory to perform at least following process:
acquiring light intensity information around the display device and motion information of the display device;
determining, according to the motion information, whether motion parameters in a preset duration are in a preset threshold range; and
if the motion parameters are in the preset threshold range, determining to adjust the display brightness of the display device according to the light intensity information; otherwise, determining not to adjust the display brightness of the display device according to the light intensity information.

7. The apparatus for adjusting display brightness of a display device of claim 6, wherein the motion parameters include one or more of speed, acceleration, or rotation angle.

8. The apparatus for adjusting display brightness of a display device of claim 6, wherein said adjusting the display brightness of the display device according to the light intensity information includes:
determining a light intensity interval to which the light intensity information around the display device belongs; and
determining a brightness coefficient of the light intensity interval to which the light intensity information belongs according to a preset mapping relationship between the light intensity interval and the brightness coefficient.

9. The apparatus for adjusting display brightness of a display device of claim 8, wherein,
the light intensity interval comprises an indoor light intensity interval and an outdoor light intensity interval; and
the outdoor light intensity interval comprises a sunny interval and a cloudy interval.

10. The apparatus for adjusting display brightness of a display device of claim 9, wherein the sunny interval comprises an away-from-sun interval and a facing-sun interval.

11. A head-mounted display device, wherein the head-mounted display device comprises an apparatus for adjusting display brightness of a display device,
wherein the apparatus for adjusting the display brightness of the display device comprises:
a memory configured to store computer-executable instructions,
a processor configured to execute the computer-executable instructions stored in the memory to perform at least the following:
acquiring light intensity information around the display device and motion information of the display device;
determining, according to the motion information, whether motion parameters in a preset duration are in a preset threshold range; and
if the motion parameters are in the preset threshold range, determining to adjust the display brightness of the display device according to the light intensity information; otherwise, determining not to adjust the display brightness of the display device according to the light intensity information.

12. The apparatus for adjusting display brightness of a display device of claim 11, wherein the motion parameters include one or more of speed, acceleration, or rotation angle.

13. The apparatus for adjusting display brightness of a display device of claim 11, wherein said adjusting the display brightness of the display device according to the light intensity information includes:
determining a light intensity interval to which the light intensity information around the display device belongs; and
determining a brightness coefficient of the light intensity interval to which the light intensity information belongs according to a preset mapping relationship between the light intensity interval and the brightness coefficient.

14. The apparatus for adjusting display brightness of a display device of claim 13, wherein,
the light intensity interval comprises an indoor light intensity interval and an outdoor light intensity interval; and
the outdoor light intensity interval comprises a sunny interval and a cloudy interval.

15. The apparatus for adjusting display brightness of a display device of claim 14, wherein the sunny interval comprises an away-from-sun interval and a facing-sun interval.

16. A non-transitory computer readable storage medium storing a computer program including instructions, which when executed by a processor causes the processor to implement the method of adjusting display brightness of a display device of claim 1.
